(19) United States
(12) Patent Application Publication
(10) Pub. No.: US 2015/0089000 A1
(43) Pub. Date: Mar. 26, 2015

(54) Method and system for sending media message across service systems

(71) Applicants: Xin Ding, Shenzhen (CN); Yan Lu, Shenzhen (CN)

(72) Inventors: Xin Ding, Shenzhen (CN); Yan Lu, Shenzhen (CN)

(73) Assignee: ZTE Corporation, Shenzhen, Guangdong (CN)

(21) Appl. No.: 14/370,152

(22) PCT Filed: May 23, 2012
(86) PCT No.: PCT/CN2012/075928

§ 371 Date: Nov. 21, 2014

(30) Foreign Application Priority Data
Oct. 26, 2011 (CN) 201110329285.X

(51) Int. Cl. H04L 12/58

(52) U.S. Cl. CPC H04L 51/10; H04L 51/14
USPC 709/206

(57) ABSTRACT

A method for sending a media message across service systems is disclosed, comprising: a media server receives a first media message at least carrying forwarding indication information from a sender in a first service system, and the media server converts the first media message into a message form corresponding to a second service system where a receiver is located through a gateway intercommunicating with the second service system and then sends the converted message to the receiver. A system for sending a media message across service systems is also accordingly disclosed. By means of the technical solution of the present disclosure, a message sender user can actively request for the conversion of a media message into a message form selected by the user and then send the converted message to a receiver, and thereby an excellent user experience may be provided.

### TECHNICAL FIELD

The present disclosure relates to the communication field and in particular to a method and a system for sending a media message across service systems.

### BACKGROUND

In recent years, with the rapid development of mobile communications and network technologies, a variety of communication services appear, including short message, multimedia message, E-mail and voicemail. Communicating with each other or transferring information with each other through short message, multimedia message, E-mail or voicemail has become indispensable in our daily work and life. There is an urgent need to achieve the intercommunication among different services.

In prior art, there are provided solutions according to which a media message is delivered to a receiver after being converted into another form. In some of those solutions, after the receiver of a message being a user in another service system is determined in a certain effective way, a server converts the message into another service message and sends the converted message to the user. For example, a multimedia massage user can send a multimedia message to an E-mail user. Generally, the receiver address of a multimedia message user is a telephone number, if the receiver address is in the format of an E-mail address, then the server converts the multimedia message into an E-mail according to the type of the receiver address and then sends the E-mail to the receiver. In some of the solutions, after determining that the receiver cannot receive a certain media message, a server converts a media message into a message form receivable to the receiver automatically or after querying the setting of the receiver user. However, in this case, the sender user cannot actively initiate the intercommunication among different service systems. In the actual application, in some cases, a sender indeed needs to actively initiate the intercommunication among different service systems, for example, the user of a voicemail service who knows the receiver user is not a voicemail user hoped to send a recorded voicemail to the receiver in an actively selected short message, multimedia message or E-mail form, or after informed by a system that the delivery of a voicemail is failed, a voicemail user hopes to actively select another service form to deliver the voicemail but not deliver the voicemail in the form selected by a system. However, no technical solution has been proposed for a message sender to actively initiate the intercommunication of services, which may lead to a poor user experience.

### SUMMARY

In view of the problem above, the present disclosure provides a method and a system for sending a media message across service systems by which a message sender can actively initiate the intercommunication of services to provide user experience.

The technical scheme of the present disclosure is as follows:

a method for sending a media message across service systems includes:

receiving, by a media server, a first media message from a sender in a first service system, wherein the first media message at least carries forwarding indication information; and

converting, by the media server, the first media message into a message form corresponding to a second service system where a receiver is located through a gateway intercommunicating with the second service system and sending the converted message to the receiver.

The step of converting, by the media server, the first media message into a message form corresponding to a second service system where a receiver is located through a gateway intercommunicating with the second service system and sending the converted message to the receiver may comprise:

determining, by the media server, that the first media message needs to be delivered to the second service system according to the forwarding indication information;

sending, by the media server, the first media message or the first media message from which the forwarding indication information has been deleted to a gateway dedicated to the intercommunication with the second service system; and

converting, by the gateway, the received first media message into a second media message and sends the second media message to the receiver.

When the first media message is an Email or a visual voicemail, the forwarding indication information is delivered to the media server as a parameter in a Simple Message Transfer Protocol (SMTP) instruction or a header field in a message packet encapsulated using Multipurpose Internet Mail Extensions (MIME) protocols.

The step of converting, by the media server, the first media message into a message form corresponding to a second service system where a receiver is located through a gateway intercommunicating with the second service system and sending the converted message to the receiver comprises:

determining, by the media server, that the first media message needs to be delivered to another service system according to the forwarding indication information;

sending, by the media server, the first media message to a gateway intercommunicating with various other service systems;

determining, by the gateway, that the first media message needs to be delivered to the second service system according to the forwarding indication information carried in the first media message; and

converting, by the gateway, the first media message into a second media message and sends the second media message to the receiver.

A system for sending a media message across service systems includes a media server and a gateway, wherein

the media server is configured to receive a first media message at least carrying forwarding indication information from a sender in a first service system, convert the first media message into a message form corresponding to a second service system where a receiver is located through a gateway intercommunicating with the second service system and send the converted message to the receiver.

The media server converting the first media message into a message form corresponding to a second service system where a receiver is located through a gateway intercommunicating with the second service system and sending the converted message to the receiver comprises:

the media server determines that the first media message needs to be delivered to the second service system according to the forwarding indication information;

the media server sends the first media message or the first media message from which the forwarding indication information has been deleted to a gateway dedicated to the intercommunication with the second service system; and

the gateway converts the received first media message into a second media message and sends the second media message to the receiver.

When the first media message received by the media server is an Email or a visual voicemail, the forwarding indication information is delivered to the media server as a parameter in a Simple Message Transfer Protocol (SMTP) instruction or a header field in a message packet encapsulated using Multipurpose Internet Mail Extensions (MIME) protocols.

The media server converting the first media message into a message form corresponding to a second service system where a receiver is located through a gateway intercommunicating with the second service system and sending the converted message to the receiver comprises:

the media server determines that the first media message needs to be delivered to another service system according to the forwarding indication information;

the media server sends the first media message to a gateway intercommunicating with various other service systems;

the gateway determines that the first media message needs to be delivered to the second service system according to the forwarding indication information carried in the first media message; and

the gateway converts the first media message into a second media message and sends the second media message to the receiver.

According to the method and the system for sending a media message across service systems, a media server receives a first media message at least carrying forwarding indication information from a sender in a first service system, converts the first media message into a message form corresponding to a second service system where a receiver is located through a gateway intercommunicating with the second service system and sends the converted message to the receiver. By means of the technical solution of the present disclosure, a message sender user can actively request for the conversion of a media message into a message form selected by the user and send the converted message to the receiver, and thereby an excellent user experience may be provided.

### BRIEF DESCRIPTION OF THE DRAWINGS

FIG. 1 illustrates the flow of the method for sending a media message across service systems disclosed herein;

FIG. 2 illustrates a specific flow of the method for sending a media message across service systems disclosed herein;

FIG. 3 illustrates another specific flow of the method for sending a media message across service systems disclosed herein;

FIG. 4 illustrates the architecture of a system according to embodiment 1;

FIG. 5 illustrates a signaling procedure according to embodiment 1;

FIG. 6 illustrates the architecture of a system according to embodiment 2; and

FIG. 7 illustrates a signaling procedure according to embodiment 2.

### DETAILED DESCRIPTION

In the present disclosure, a media server receives a first media message at least carrying forwarding indication information from a sender in a first service system, converts the first media message into a message form corresponding to a second service system where a receiver is located through a gateway intercommunicating with the second service system and then sends the converted message to the receiver.

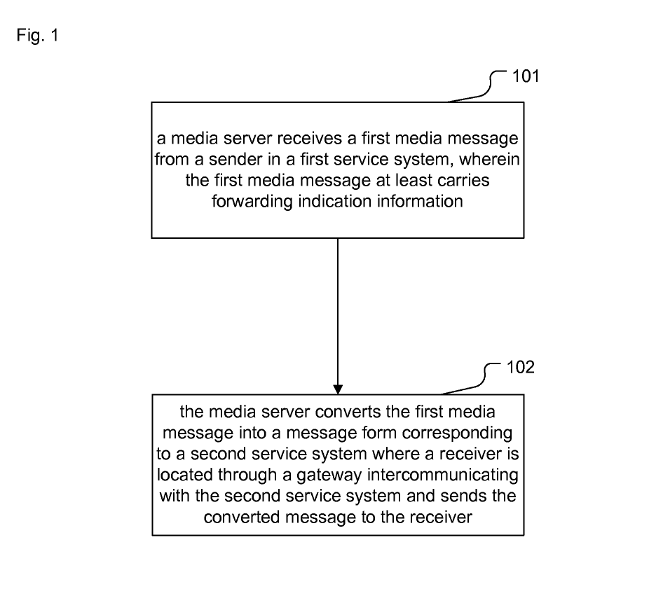

FIG. 1 illustrates the flow of the method for sending a media message across service systems disclosed herein, and as shown in FIG. 1, the method includes:

Step 101: a media server receives a first media message from a sender in a first service system, wherein the first media message at least carries forwarding indication information.

Here, the forwarding indication information indicates the message form into which the media message is converted and then sent to the receiver according to the request of the user.

Step 102: the media server converts the first media message into a message form corresponding to a second service system where a receiver is located through a gateway intercommunicating with the second service system and sends the converted message to the receiver.

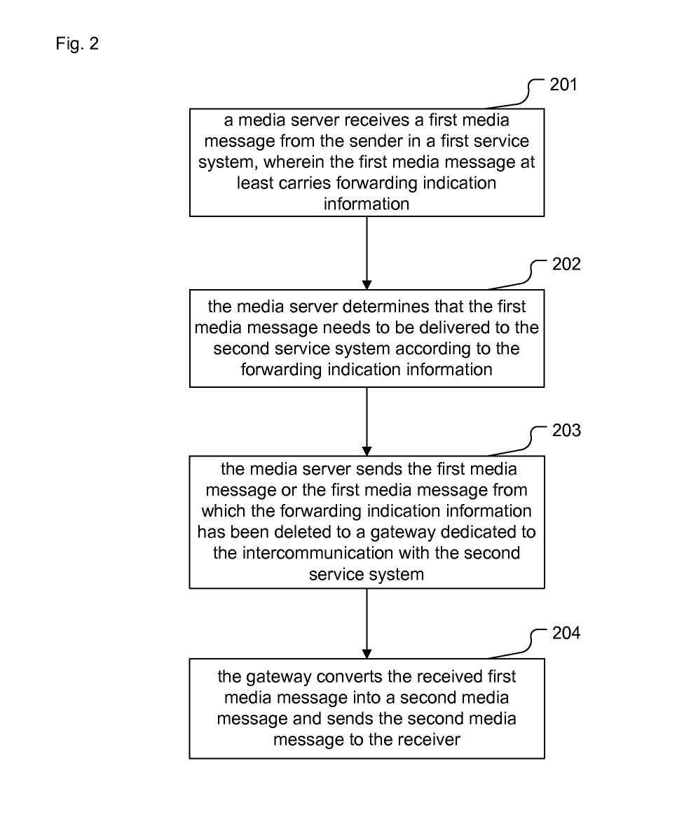

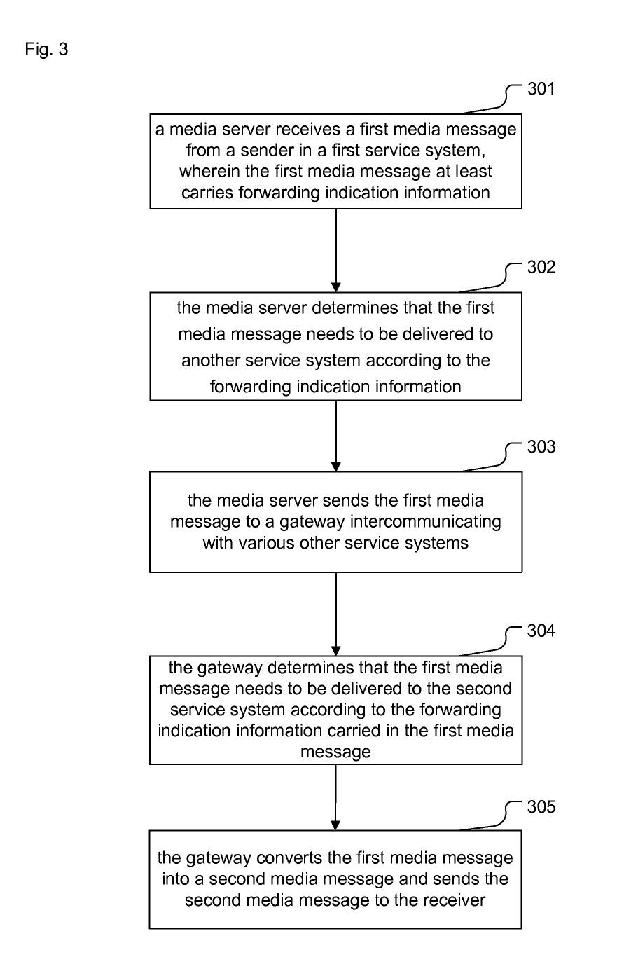

The present disclosure is generally implemented in two forms, and the specific flows of each implementation are shown in FIG. 2 and FIG. 3.

As shown in FIG. 2, the method for sending a media message across service systems disclosed herein may include the following steps:

Step 201: a media server receives a first media message from the sender in a first service system, wherein the first media message at least carries forwarding indication information.

Step 202: the media server determines that the first media message needs to be delivered to the second service system according to the forwarding indication information.

Step 203: the media server sends the first media message or the first media message from which the forwarding indication information has been deleted to a gateway dedicated to the intercommunication with the second service system.

Step 204: the gateway converts the received media message into a second media message and sends the second media message to the receiver.

As shown in FIG. 3, the method for sending a media message across service systems disclosed herein may include the following steps:

Step 301: a media server receives a first media message from the sender in a first service system, wherein the first media message at least carries forwarding indication information.

Step 302: the media server determines that the first media message needs to be delivered to another service system according to the forwarding indication information;

Step 303: the media server sends the first media message to a gateway intercommunicating with various other service systems; and

Step 304: the gateway determines that the first media message needs to be delivered to the second service system according to the forwarding indication information carried in the first media message; and

Step 305: the gateway converts the first media message into a second media message and sends the second media message to the receiver.

A system for sending a media message across service systems is also accordingly disclosed in an embodiment of the present disclosure, which includes a media server and a gateway, wherein

the media server is configured to receive a first media message at least carrying forwarding indication information from the sender in a first service system, convert the first media message into a message form corresponding to a second service system where the receiver is located through a gateway intercommunicating with the second service system and then send the converted message to the receiver.

The process that the media server converts the first media message into a message form corresponding to a second service system where the receiver is located through a gateway intercommunicating with the second service system and sends the converted message to the receiver is as follows:

the media server determines that the first media message needs to be delivered to the second service system according to the forwarding indication information;

the media server sends the first media message or the first media message from which the forwarding indication information has been deleted to a gateway dedicated to the intercommunication with the second service system; and

the gateway converts the received media message into a second media message and sends the second media message to the receiver.

The process that the media server converts the first media message into a message form corresponding to a second service system where the receiver is located through a gateway intercommunicating with the second service system and sends the converted message to the receiver is as follows:

the media server determines that the first media message needs to be delivered to another service system according to the forwarding indication information;

the media server sends the first media message to a gateway intercommunicating with various other service systems;

the gateway determines that the first media message needs to be delivered to the second service system according to the forwarding indication information carried in the first media message; and

the gateway converts the first media message into a second media message and sends the second media message to the receiver.

The technical scheme is described below in detail with reference to accompanying drawings when read in conjunction with embodiments.

### EMBODIMENT 1

It is described in the embodiment that the sender in a first service system sends a first media message carrying forwarding indication information to a media server, after receiving the media message, the media server determines that the user needs to forward the message to a second service system according to the forwarding indication information and then forwards the media message to a gateway intercommunicating with the second service system, and the gateway converts the media message and then sends the converted media message to the second service system.

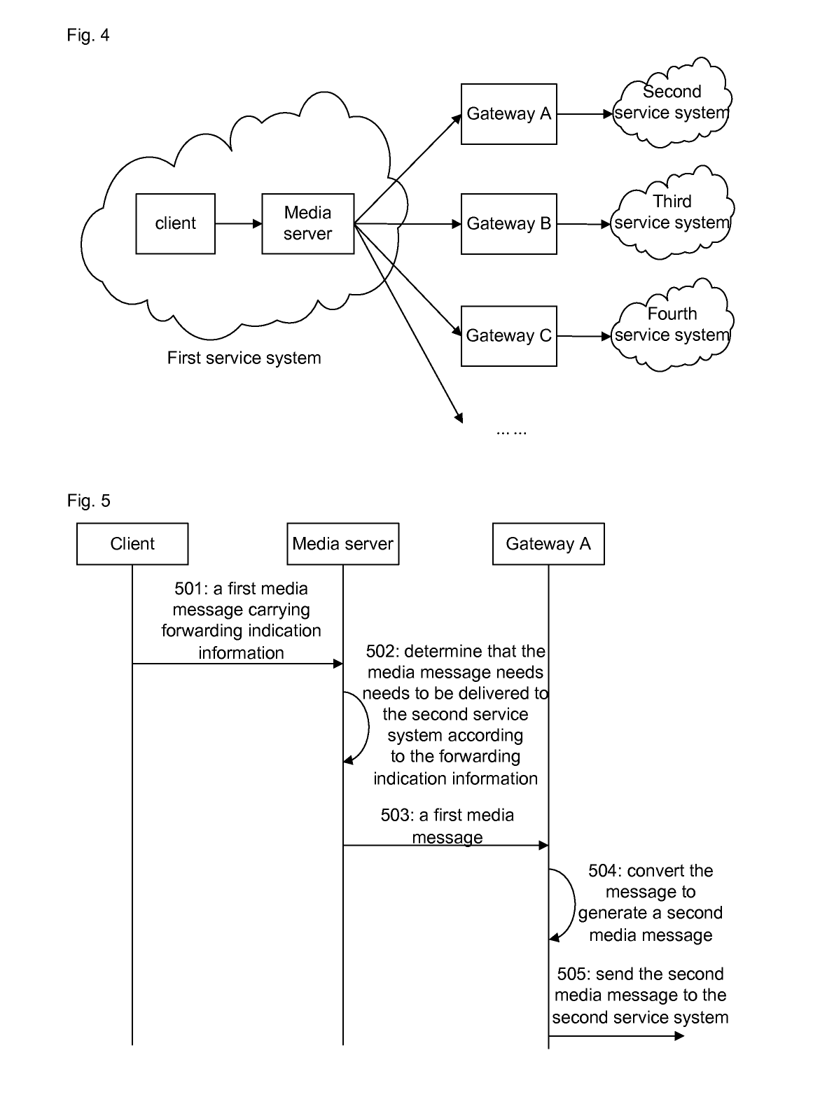

As shown in FIG. 4 which schematically illustrates the system architecture involved in the embodiment, the sender of a media message is located in a first service system which includes a client and a media server which intercommunicates with a second service system through a gateway A, a third service system through a gateway B and a fourth service system through a gateway C.

As shown in FIG. 5, the signaling procedure of the embodiment specifically includes the following steps:

Step 501: in the first service system, a client sends the media server a first media message which should be finally delivered to the second service system according to the request of the user, thus, forwarding indication information is carried in the first media message to indicate the location of the receiver of the message in the second service system.

For example, assume that the first media message is an Email or a visual voicemail, the forwarding indication information is delivered to the media server as a parameter in a Simple Message Transfer Protocol (SMTP) instruction or a header field in a message packet encapsulated using Multipurpose Internet Mail Extensions (MIME) protocols.

Step 502: after receiving the first media message, the media server determines that the media message needs to be delivered to the second service system (e.g. short message service, multimedia message service) according to the forwarding indication information carried in the message.

The forwarding indication information carried by the header field parameter of MIME can be indicated by carrying an extension parameter, forward=SMS, in the Cotent-Type of the header to indicate that the message is desired to be forwarded to an SMS system and finally sent to the receiver in a short message form.

Step 503: the media server sends the first media message to the gateway A dedicated to the intercommunication with the second service system, in this step, the first media message may carry the forwarding indication information or not.

Step 504: the gateway A converts the received first media message into a second media message receivable to the second service system, for example, if the second service system is a short message service system, then a submit_sm request accordant with a Short Message Peer-to-Peer Protocol (SMPP) is generated; if the second service system is a multimedia message service system, then an MM4_forward.REQ request accordant with relative standards of the 3rd Generation Partnership Project (3GPP) is generated.

After receiving the media message in an MIME format, the gateway extracts each information unit of the MIME, converts the voice information in the message into text information as needed, selects necessary text content as the user data of a short message, carries out format conversion according to the receiver address carried in the header of the MIME if necessary, for example, searches for the telephone number of the user from preset user information according to an E-mail address, and finally sends the converted short message out via a short message gateway.

Step 505: the gateway A sends the second media message to the second service system, for example, if the second service system is a short message service system, then the second media message, that is, the ubmit_sm request, is sent to a Short Message Service Center (SM-SC) through an SMPP protocol; and if the second service system is a multimedia message service system, then the second media message, that is, the MM4_forward.REQ request, is sent to a Multimedia Messaging Service (MMS) relay server the receiver belongs to through an SMTP protocol.

### EMBODIMENT 2

It is described in the embodiment that the sender in a first service system sends a first media message carrying forwarding indication information to a media server, after receiving the media message, the media server finds the forwarding indication information carried in the media message and then sends the media message to a gateway device capable of intercommunicating with various service systems; the gateway determines that the user needs to forward the message to a second service system according to the forwarding indication information and then converts the media message and forwards the converted media message to the second service system.

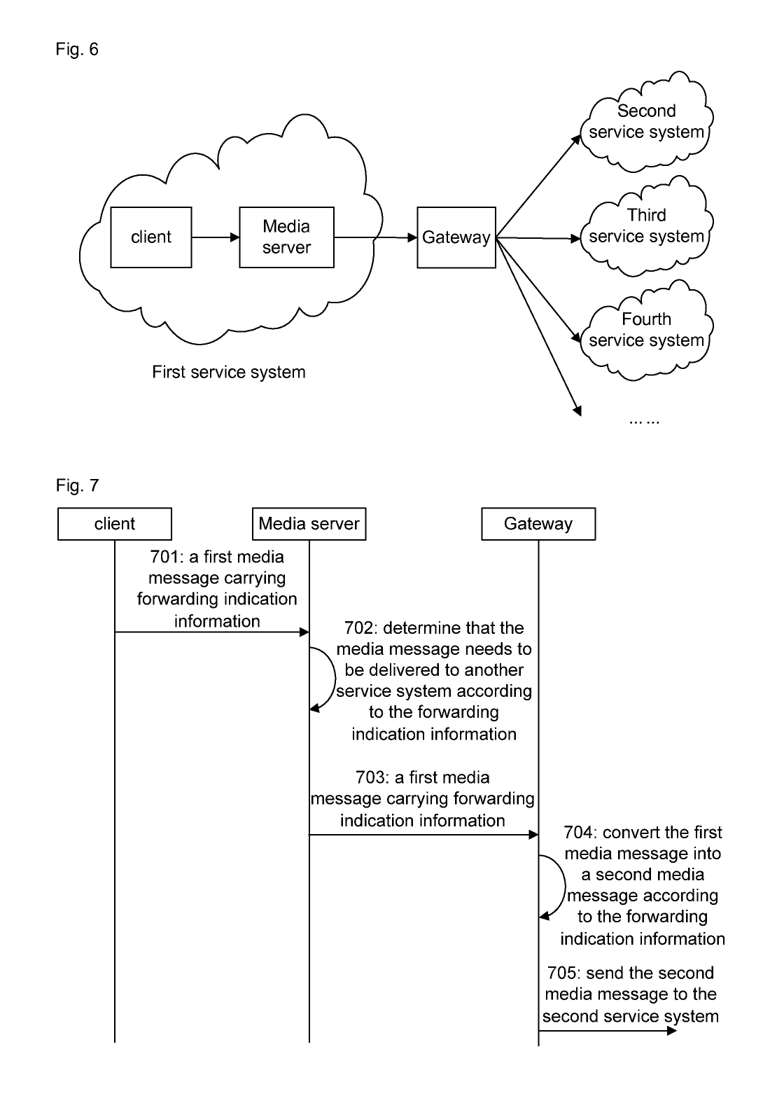

As shown in FIG. 6 which schematically illustrates the system architecture involved in the embodiment, the sender of a media message is located in a first service system which includes a client and a media server which can intercommunicate with various service systems via a gateway, wherein the service systems includes a second service system, a third service system, a fourth service system and the like.

As shown in FIG. 7, the signaling procedure of the embodiment specifically includes the following steps:

Step 701: in the first service system, a client sends the media server a first media message which should be finally delivered to the second service system according to the request of the user, thus, forwarding indication information is carried in the first media message to indicate the location of the receiver of the message in the second service system.

For example, assume that the first media message is an Email or a visual voicemail, the forwarding indication information may be delivered to the media server as a parameter in a Simple Message Transfer Protocol (SMTP) instruction or a header field in a message packet encapsulated using Multipurpose Internet Mail Extensions (MIME) protocols.

Step 702: after receiving the first media message, the media server finds the forwarding indication information carried in the first media message and then determines that the media message needs to be delivered to another service system.

Step 703: the media server sends the first media message to a gateway for intercommunicating with various other service systems, in this step, the first media message still carries the forwarding indication information.

Step 704: after receiving the first media message, the gateway determines that the media message needs to be delivered to the second service system (e.g. short message service, multimedia message service), then the gateway converts the first media message into a second media message receivable to the second service system, for example, if the second service system is a short message service system, then a submit_sm request accordant with a Short Message Peer-to-Peer Protocol (SMPP) is generated; if the second service system is a multimedia message service system, then an MM4_forward.REQ request accordant with relative standards of the 3GPP is generated.

Step 705: the gateway sends the second media message to the second service system, for example, if the second service system is a short message service system, then the second media message, that is, the ubmit_sm request, is sent to a Short Message Service Center (SM-SC) via an SMPP protocol; and if the second service system is a multimedia message service system, then the second media message, that is, the MM4_forward.REQ request, is sent to the Multimedia Messaging Service (MMS) relay server the receiver belongs to via an SMTP protocol.

The mentioned above is merely preferred embodiments of the present disclosure but is not to be construed as limitation to the protection scope of the present disclosure.

1. A method for sending a media message across service systems, comprising:
receiving, by a media server, a first media message from a sender in a first service system, wherein the first media message at least carries forwarding indication information; and
converting, by the media server, the first media message into a message form corresponding to a second service system where a receiver is located through a gateway intercommunicating with the second service system and sending the converted message to the receiver.

2. The method according to claim 1, wherein the step of converting, by the media server, the first media message into a message form corresponding to a second service system where a receiver is located through a gateway intercommunicating with the second service system and sending the converted message to the receiver comprises:
determining, by the media server, that the first media message needs to be delivered to the second service system according to the forwarding indication information;
sending, by the media server, the first media message or the first media message from which the forwarding indication information has been deleted to a gateway dedicated to the intercommunication with the second service system; and
converting, by the gateway, the received first media message into a second media message and sends the second media message to the receiver.

3. The method according to claim 2, wherein when the first media message is an E-mail or a visual voicemail, the forwarding indication information is delivered to the media server as a parameter in a Simple Message Transfer Protocol (SMTP) instruction or a header field in a message packet encapsulated using Multipurpose Internet Mail Extensions (MIME) protocols.

4. The method according to claim 1, wherein the step of converting, by the media server, the first media message into a message form corresponding to a second service system where a receiver is located through a gateway intercommunicating with the second service system and sending the converted message to the receiver comprises:
determining, by the media server, that the first media message needs to be delivered to another service system according to the forwarding indication information;
sending, by the media server, the first media message to a gateway intercommunicating with various other service systems;
determining, by the gateway, that the first media message needs to be delivered to the second service system according to the forwarding indication information carried in the first media message; and
converting, by the gateway, the first media message into a second media message and sends the second media message to the receiver.

5. A system for sending a media message across service systems, comprising: a media server and a gateway, wherein
the media server is configured to receive a first media message at least carrying forwarding indication information from a sender in a first service system, convert the first media message into a message form corresponding to a second service system where a receiver is located through a gateway intercommunicating with the second service system and send the converted message to the receiver.

6. The system according to claim 5, wherein the media server converting the first media message into a message form corresponding to a second service system where a receiver is located through a gateway intercommunicating with the second service system and sending the converted message to the receiver comprises:
the media server determines that the first media message needs to be delivered to the second service system according to the forwarding indication information;
the media server sends the first media message or the first media message from which the forwarding indication information has been deleted to a gateway dedicated to the intercommunication with the second service system; and
the gateway converts the received first media message into a second media message and sends the second media message to the receiver.

7. The system according to claim 6, wherein when the first media message received by the media server is an E-mail or a visual voicemail, the forwarding indication information is delivered to the media server as a parameter in a Simple Message Transfer Protocol (SMTP) instruction or a header field in a message packet encapsulated using Multipurpose Internet Mail Extensions (MIME) protocols.

8. The system according to claim 5, wherein the media server converting the first media message into a message form corresponding to a second service system where a receiver is located through a gateway intercommunicating with the second service system and sending the converted message to the receiver comprises:
the media server determines that the first media message needs to be delivered to another service system according to the forwarding indication information;
the media server sends the first media message to a gateway intercommunicating with various other service systems;
the gateway determines that the first media message needs to be delivered to the second service system according to the forwarding indication information carried in the first media message; and
the gateway converts the first media message into a second media message and sends the second media message to the receiver.
